(19) United States
(12) Patent Application Publication
(10) Pub. No.: US 2026/0070228 A1
(43) Pub. Date: Mar. 12, 2026

(54) Grinding robot for grinding a surface with a grinding device

(71) Applicant: JÖST GmbH, Wald-Michelbach (DE)

(72) Inventors: Klaus NEY, Bürstadt (DE); Dominic JÖST, Absteinach (DE)

(73) Assignee: JÖST GmbH, Wald-Michelbach (DE)

(21) Appl. No.: 19/108,662

(22) PCT Filed: Sep. 5, 2023
(86) PCT No.: PCT/EP2023/074338

§ 371 Date: Mar. 4, 2025

(30) Foreign Application Priority Data
Sep. 6, 2022 (DE) 10 2022 122 584.4

(51) Int. Cl. B25J 11/00; B24B 41/06

(52) U.S. Cl. CPC B25J 11/0065; B24B 41/06

(57) ABSTRACT

A grinding robot has a grinding device for grinding a surface using a grinding means, a movement device for moving the grinding device over the surface, and a suction device for suctioning a grinding robot housing onto the surface. The movement device has two or more suction lifter elements which are suctioned onto the surface by negative pressure. Each suction lifter element is supported on the grinding robot housing via a rotary drive device and the grinding robot housing can thereby be set into a rotational element is configured as a grinding plate. The grinding plate has suction openings for movement relative to a suction lifter element suctioned onto the surface. A suction lifter suctioning the grinding plate onto the surface. The grinding disc fastened to the grinding plate has an opening, which is arranged in an at least partially overlapping manner with the suction opening in the grinding plate.

### CROSS-REFERENCE TO RELATED APPLICATION

This application is a national stage application, filed under 35 U.S. C. § 371, of International Patent Application PCT/EP2023/074338, filed on Sep. 5, 2023, which claims the benefit of German Patent Application DE 10 2022 122 584.4, filed on Sep. 6, 2022.

### TECHNICAL FIELD

The application relates to a grinding robot for grinding a surface with a grinding device by means of which the surface can be ground using a grinding means, and with a movement device by means of which the grinding device can be moved over the surface, wherein the grinding device and the movement device are arranged on or in a grinding robot housing.

### BACKGROUND

To grind down a surface, a suitable grinding means such as sandpaper coated with grinding grains or a file can be pressed against the surface by hand and moved over the surface. Manual grinding is particularly suitable for smaller surface areas, as the simultaneous pressing and moving of sandpaper or a file on the surface is strenuous. However, uneven surfaces or objects with complex shapes in particular can be ground well manually.

In order to grind larger surfaces, grinding tools known in practice such as belt sanders, orbital sanders or angle sanders can be used. With such grinding tools, a belt-shaped or disc-shaped grinding means with a specified grinding grain is usually set in motion with the help of a drive, such as an electric motor. In the case of a belt sander, the object with the surface to be ground can be moved towards and pressed against the grinding belt, which usually moves continuously. With orbital sanders and angle sanders, the sander is usually pressed against the surface to be ground and the plate-or disc-shaped grinding means is set in motion by an electric motor in order to carry out the grinding process and grind the surface while the grinding means is pressed against the surface. A user must either press the object with the surface to be ground against the moving grinding means, or press the grinding device with the moving grinding means against the surface and move the device over the surface in order to grind the surface.

Long-neck sanders or giraffe sanders are grinding devices in which a grinding device head is articulated on a longer handle bar with a length of around 2 metres. A grinding means is movably supported on the grinding device head and can be set in motion by a drive device. A user grasps a free end of the handle bar and, by suitable handling and movement of the handle bar, can guide the grinding device head, which is articulatedly mounted on an opposite end of the handle bar, with the moving grinding means over the surface to be ground. A giraffe sander can be used to grind larger wall surfaces, for example. However, prolonged handling and use of a giraffe sander is strenuous, as the grinding device head has a considerable dead weight and must be pressed against the wall surface to be ground and continuously guided over the wall surface during the grinding process. However, ceiling surfaces can also be ground with this type of giraffe sander.

Furthermore, grinding robots are known with which a surface can be ground automatically and without continuous operation and monitoring by a user. Such grinding robots regularly have a grinding device by means of which the surface can be ground with a grinding means, and a movement device by means of which the grinding device can be moved over the surface. The movement device usually has several drivable wheels, which are either mounted in a steerable manner or can be driven differently relative to each other, so that, for example, a cornering movement or a rotary movement of the grinding robot on the spot can be achieved by a rotary movement at different speeds or an oppositely directed rotary movement of two wheels. However, such a grinding robot must be placed on a horizontal or at least approximately horizontal surface and can only move over the surface with the help of the driven wheels. The pressure of the grinding means against the surface can only be generated by the dead weight of the grinding robot. Such grinding robots can be used to automatically grind large floor surfaces, for example, and in particular wooden floors or stone floors, without the need for user intervention. However, such grinding robots cannot be used to automatically grind wall surfaces or ceilings.

### SUMMARY

The present application improves a grinding robot with the features mentioned at the outset in such a way that the grinding robot can be used in as many ways as possible and, for example, wall surfaces can also be ground automatically with the grinding robot.

This is achieved in that the grinding robot has a suction device by means of which the grinding robot housing can be suctioned onto the surface while a grinding process is being carried out with the grinding device. The suction device can be used to influence and predetermine a contact pressure with which the grinding robot and thus also the grinding device is pressed against the surface. In particular, with a suitably equipped suction device, it is also possible for the upper housing of the grinding robot to be suctioned against a wall surface or a ceiling surface, for example, while a grinding process is being carried out with the grinding device. The grinding robot can therefore also be used to grind wall surfaces or ceiling surfaces automatically and without manual intervention. A suction power of the suction device can be specified in such a way that the influence of the dead weight of the grinding robot on the contact pressure on the surface is taken into account. For example, the suction power can be comparatively low if the grinding robot is placed on a floor surface or on a horizontal or slightly inclined surface. In comparison, the suction power can be significantly higher if the upper housing of the grinding robot is placed against a vertical wall surface or a ceiling surface and the dead weight of the grinding robot generates a weight force parallel to the wall surface or away from the ceiling surface, which must be compensated for by the suction device.

The grinding device can, for example, be configured like a belt sander and continuously move a grinding means belt pressed against the surface to be ground in a predetermined grinding belt circulation direction. The grinding device can also be configured like an orbital sander and continuously move a grinding means plate back and forth during a grinding process. The grinding means is conveniently interchangeable so that, if necessary, a grinding means with a reduced grinding means effect due to many grinding processes can be replaced with a new grinding means with a high grinding means effect. Grinding means with different grinding grain sizes can also be used, for example, to first carry out a coarse grinding of the surface and then a fine grinding of the surface to reduce unevenness in the surface.

The movement device can have one driven wheel or a plurality of driven wheels or rollers with which the grinding robot housing, which is suctioned and pressed against the surface with the suction device, can be moved over the surface.

According to a particularly advantageous embodiment, it is provided that the movement device has two or more suction elements, which are arranged spaced apart from one another and face the surface and which can be suctioned onto the surface by a negative pressure that can be generated by means of a negative pressure device, and that each suction lifter element is supported on the grinding robot housing via a rotary drive device and therefore the grinding robot housing can, by means of the rotary drive device, be set into a rotational movement relative to a suction lifter element suctioned onto the surface. By alternately suctioning two or more suction lifter elements onto the surface with a sufficiently strong negative pressure and thereby fixing them to the surface and rotating the grinding robot housing around the suction element fastened to the surface with the aid of the rotary drive device, a directed movement of the grinding robot housing over the surface can be achieved. A directional movement is any movement with which the grinding robot housing does not rotate exclusively about a predetermined axis of rotation, but is moved from one surface area to another surface area that is not congruent. If, for example, two suction lifter elements spaced apart from each other are alternately suctioned in and the grinding robot housing is rotated by an angle of, for example, a few degrees, 90 degrees or 180 degrees around the suction lifter element that is suctioned in and thus fastened to the surface, a slightly or strongly undulating directional movement of the grinding robot housing over the surface can be achieved. Depending on the desired grinding duration or grinding effect, the upper housing of the grinding robot can also be rotated several times around a suction lifter element fastened to the surface so that the grinding device with the grinding means material grinding the surface is moved in a circle around the suction lifter element fastened to the surface and guided over the surface before another suction lifter element is fastened to the surface and the suction lifter element previously fastened to the surface is released from the surface again to enable a directional movement of the grinding robot housing over the surface.

For many applications, a grinding robot with two suction lifter elements spaced apart from each other is advantageous. By alternately fastening the two suction lifter elements and rotating the grinding robot housing around the respective fastened suction lifter element, a more or less undulating and directional movement of the grinding robot housing over the surface can be achieved with just two suction lifter elements. A small number of suction lifter elements enables the grinding robot to be manufactured cost-effectively and, compared to a grinding robot with three or more suction lifter elements, a lower dead weight of the grinding robot, which has a favourable effect on the negative pressure that must be generated by the negative pressure generation device and also reduces the power consumption required for this during operation. By using three or more suction lifter elements, both a less undulating and more even movement of the grinding robot housing over the surface and also complex movement patterns of the grinding robot housing over the surface can be enabled and carried out.

It is conceivable that the negative pressure that can be generated with the negative pressure generation device can be specified separately for each suction lifter element and can be changed individually during operation of the grinding robot. It is also possible that a separate negative pressure generation device is provided for each suction lifter element and only assigned to this suction lifter element in order to be able to preset and change the negative pressure generated on an individual suction lifter element completely independently of a negative pressure generated on another suction lifter element.

Preferably, it is optionally provided that the grinding device has at least one grinding plate with a grinding plate that can be fastened to the grinding plate and can be set in a rotational movement by a rotary drive device. By using a grinding plate with a grinding wheel that can be fastened to it, the grinding wheel can easily be set in a rotational movement in order to grind the surface with the rotating grinding wheel. The grinding plate can have a circular peripheral edge. The grinding plate can also have a wavy peripheral edge in order to prevent a circular peripheral edge of a surface area ground off during the rotational movement of the grinding plate being created during a rotational movement of the grinding plate, which cannot be ground off completely or only with considerable effort during the movement of the grinding wheel housing away from the surface. Conveniently, the grinding plate can be detachably fastened to the grinding plate and can be replaced if necessary.

A rotational movement can be generated particularly easily and cost-effectively with a suitable configuration of the drive device. A rotating grinding plate can, for example, be arranged and supported on the grinding robot housing via a rotatably mounted shaft, which enables a structurally simple and cost-effective implementation compared to a grinding means belt driven in circulation or an eccentrically reciprocating orbital grinding means.

According to a particularly advantageous embodiment, it is provided that one suction lifter element or a plurality of suction lifter elements are configured as grinding plates, wherein the grinding plate has suction openings spaced apart from a grinding plate edge, for suctioning the grinding plate onto the surface, and that the grinding disc fastened to the grinding plate has, spaced apart from the grinding disc belt, one or a plurality of openings which are arranged in an at least partially overlapping manner with the one suction opening or the plurality of suction openings in the grinding plate. The simultaneous use of a suction lifter element as a grinding plate or as a component of the grinding device means that the grinding robot can be manufactured particularly cost-effectively and with a low dead weight. It has been shown that with a grinding plate provided with one or more suction openings in combination with a grinding disc, which also has one or more overlapping openings, a suction air flow can be generated through the suction openings formed in the grinding plate by means of which the grinding plate can be suctioned onto the surface and fixed and thus acts and can be used as a suction lifter element. The negative pressure generated between a grinding plate configured in this way and the surface can easily be generated with a suitably configured negative pressure generation device and also enables the suction robot housing to be suctioned onto a wall surface or a ceiling surface via the grinding plate suctioned onto the surface. The negative pressure required for this can, for example, be generated by a rotating suction fan, which generates an air flow guided from the surface through the suction openings in the grinding plate, so that when the grinding plate approaches the surface or when the grinding plate is placed on the surface, a corresponding negative pressure is generated between the grinding plate and the surface, through which the grinding plate is suctioned onto the surface and acts as a suction lifter element.

The use of a grinding plate with suction openings as a suction lifter element also has the further advantage that the grinding dust generated during a grinding process is also suctioned through the grinding plate and away from the surface and the grinding means by continuously suctioning air through the suction openings of the grinding plate. In this way, it can be achieved without additional structural measures that the grinding dust generated during a grinding process does not accumulate on the grinding means or on a grinding disc and adhere to it, thereby reducing the grinding effect of the grinding means or the grinding disc.

Conveniently, the grinding robot has two suction lifter elements, each configured as a grinding plate. By alternating the operation of the two suction lifter elements, each suction lifter element is alternately used either as a suction lifter element and fixed on the surface or used as a grinding plate and rotated over the surface in order to grind the surface area covered by the rotating grinding disc with the grinding disc fixed on the grinding plate.

A separate rotary drive device can be provided for each suction lifter element, by means of which a comparable slow rotary movement of the grinding robot housing around the suction lifter element fastened to the surface can be effected. A separate rotary drive device can also be provided for each grinding plate and arranged in such a way that the grinding plate can be set into a rapid rotational movement with the relevant rotary drive device in order to be able to move the grinding disc attached to the grinding plate in a rapidly rotating manner over the surface in order to grind the surface.

According to one embodiment, it is optionally provided that the rotary drive device is configured in such a way that the rotary drive device can be used to set at least one grinding plate configured as a suction lifter element either into a first slow rotary movement for a rotational movement of the grinding robot housing about the suction lifter element suctioned onto the surface or into a second fast rotary movement for a rotational movement of the grinding plate during a grinding process. The same rotary drive device can then be used during a grinding process to either cause a slow rotary movement of the grinding robot housing around the suction lifter element fastened to the surface, or to set the grinding plate into a rapid rotary movement and thus carry out a grinding process. By using a single rotary drive device that is suitable and intended for both types of movement, it is possible to dispense with the use of two separate rotary drive devices, which would require more space in the upper grinding robot housing and would increase the dead weight of the grinding robot.

It is expedient to optionally provide that the rotary drive device has a worm gear which is driven by an electric motor. Depending on the speed of the electric motor, which is specified during an operating state of the rotary drive device, both the first slow rotary movement and the second fast rotary movement can be realised. It is also conceivable that a transmission with two different reduction ratios is used so that the electric motor can be operated at the same speed for both operating states and the different speeds of rotation are realised by selecting and specifying the reduction ratio of the transmission.

If a suction lifter element is not configured as a grinding plate and, for example, a suction lifter element is arranged next to a grinding plate that cannot also be used as a suction lifter element, it may be expedient and optional for the rotary drive device to be brought into operative connection either with the suction lifter element or with the grinding plate in order to be able to operate both the suction lifter element and the grinding plate with the aid of a single rotary drive device and set them into a slow or fast rotary movement. For this purpose, for example, an electric motor of the rotary drive device can be pivotably supported on the grinding robot housing and, depending on the desired operating state, can be brought into operative connection either with the suction lifter element or with the grinding plate. In both cases, the electric motor can be combined with a gear reduction or gear overdrive in order to effect the first slow rotary movement or the second fast rotary movement.

A separate negative pressure generation device can be provided for each suction lifter element. In this way, the negative pressure generated at a suction lifter element can be predetermined independently of the use of another suction lifter element and the negative pressure generated there. According to one embodiment, it is provided that the negative pressure generation device has a suction fan which is connected to the two or more suction lifter elements via a branching suction duct, so that a negative pressure can be generated at the two or more suction lifter elements when the suction fan is in operation. The suction fan can, for example, be arranged in a portion of the suction channel that is common to all connected suction lifter elements. During operation, the suction fan generates an air flow that is suctioned into the suction channel in the area of the suction lifter elements and conveyed away from the suction elements by the suction fan. The use of a single suction fan, which is connected to the two or more suction lifter elements via a branching suction channel and can generate a negative pressure there, enables savings to be made in terms of manufacturing costs and the dead weight of the grinding robot.

In an advantageous manner, it is optionally provided that the suction device has a valve device with which the negative pressure that can be generated at a suction lifter element with the negative pressure generation device can be controlled. The valve device is expediently configured so that the negative pressure that can be generated there can be specified individually for each suction lifter element and as independently as possible of the other suction lifter elements. This can be achieved, for example, by a blocking flap arranged in the area of a branch of the branching suction duct, which either completely blocks one of the branching suction duct portions and thus supplies the entire suction power generated by the negative pressure generation device via the other suction duct portion to the suction lifter element connected via this suction duct portion, or partially or completely releases both branching suction duct portions, so that a negative pressure is generated simultaneously at the two suction lifter elements connected to it.

It can also be provided that the negative pressure generation device is continuously connected to all suction lifter elements and that a suction flow that is not controlled and modified by a valve device is continuously generated during the operation of the negative pressure generation device. In the case of a suction lifter element that does not rotate or only rotates with a first slow rotary movement, the negative pressure thus generated on the suction lifter element leads to suction and to reliable fixing of the suction lifter element to the surface. If, on the other hand, a suction lifter element configured as a grinding plate is set in a second fast rotational movement, the effect of the negative pressure is reduced and a rotational movement of the grinding plate with a reduced contact pressure on the surface compared to a suction lifter element is enabled and effected.

The air flow generated by the negative pressure generation device can be blown out through a suitable opening in the grinding robot housing and distributed into the environment. However, experience has shown that grinding dust is continuously generated during a grinding process, which is at least partially captured by the air flow and entrained.

In order to prevent the grinding dust suctioned in by the negative pressure generation device and carried along in the air flow generated by the negative pressure generation device from being released and distributed into the environment in an uncontrolled manner, it may be expedient for the air flow generated by the negative pressure generation device to be guided through a filter device with which the grinding dust can be filtered out of the air flow. The filter device can have a replaceable or regenerable filter element.

According to one embodiment, it is provided that the negative pressure generation device is connected via an extraction hose to an extraction air filter device arranged outside the grinding robot housing. The suction hose can be a flexible or elastic plastics hose. It is expedient that the suction hose has a length of several metres and the lowest possible dead weight in order to enable the grinding robot housing to be moved over a large surface area without the externally arranged suction air filter device having to be adjusted or moved in between. It may be advantageous for a part of the negative pressure generation device or the complete negative pressure generation device to be arranged on or next to the externally arranged extraction air filter device. In this way, the dead weight of the grinding robot housing moving over the surface with the components arranged therein is additionally reduced.

In order to minimise the impact on and pollution of the environment surrounding the surface to be ground during the grinding process, an optional grinding dust seal can be arranged along a peripheral edge around each grinding plate. A suitably configured grinding dust seal can be used to prevent the grinding dust generated during a grinding process from being released into the environment in an uncontrolled manner.

The grinding dust seal can be a brush or an elastic sealing lip, for example, which is arranged along a peripheral edge around each grinding plate. A distance between the grinding dust seal and the peripheral edge of the grinding plate can be specified in such a way that an undesired discharge of grinding dust is reduced as far as possible, but a rotational movement of the grinding plate is not hindered by the grinding dust seal.

If the use of grinding dust seals around each grinding plate is combined with an extraction air filter device, a grinding process can be carried out automatically with a grinding robot configured in this way, during which no grinding dust or at least only a small amount of grinding dust is released into the environment. In this way, even large wall and ceiling surfaces and, if necessary, floor surfaces in a room can be ground without the room becoming significantly soiled. This is particularly advantageous when carrying out a grinding process in rooms that are already occupied.

The energy required to operate the grinding robot can, for example, be connected to a power distribution network permanently installed in a building or temporarily, for example to a transportable power distributor or construction site power distributor, by means of a wired connection of the grinding robot. The cable-connected power supply means that there is no need for a power supply device on or in the grinding robot housing, which additionally reduces the dead weight of the grinding robot and favours efficient operation of the grinding robot.

According to one embodiment, it is provided that an energy storage device is arranged on or in the grinding robot housing and is connected to the grinding device, to the suction device and/or to the movement device in an energy-transmitting manner. An energy storage device arranged in the grinding robot housing can enable self-sufficient and cable-free operation of the grinding robot for at least a predeterminable period of time. In addition, an energy storage device carried in the grinding robot housing can bridge an unplanned interruption of the connection to an external energy supply device or an interruption of the energy supply itself, thereby preventing the suction device from being temporarily unable to operate properly and the grinding robot housing from being suctioned onto the surface to be ground with a sufficient suction effect. The energy storage device carried along can therefore either be configured and provided only to bridge unintentional interruptions of an external energy supply, or can enable completely self-sufficient operation of the grinding robot for a predetermined period of time.

The grinding robot conveniently has a contact pressure sensor device. During operation of the grinding robot, the contact pressure sensor device can be used to detect a contact pressure of the grinding robot housing suctioned onto the surface or a suction effect of individual suction lifter elements. If the contact pressure detected by the contact pressure sensor device falls below a specified minimum contact pressure, a visual or acoustic warning can be generated. It is also conceivable that the grinding robot housing is moved to a position that is as safe and reliable as possible, such as to the lower edge of a wall surface, if the contact pressure falls below a specified minimum contact pressure that is detected by the contact pressure sensor device. If necessary, additional safety measures can be initiated, for example to prevent the grinding robot housing from accidentally falling from a wall or ceiling surface. Airbags can also be carried in the grinding robot housing and triggered when the contact pressure falls below a critical level in order to reduce or completely prevent damage to the grinding robot and the surrounding area if the grinding robot housing then falls unavoidably.

Optionally, it can also be provided that the grinding robot has a surface edge detection device. In this way, it can be avoided that the grinding robot is moved beyond a predetermined edge of a surface to be ground and the suction device is then no longer able to reliably suction the grinding robot housing onto the surface. The surface edge detection device can, for example, have an optical detection device or a distance detection device operated with ultrasound. Depending on the configuration of the surface edge detection device, edges or obstacles protruding from the surface to be ground, such as a door frame in a wall surface, can be detected. Edges or holes in a surface can also be recognised which could be driven over by the grinding robot and could lead to a reduction or complete loss of the suction effect of the grinding robot on the surface in question and should therefore be avoided.

### BRIEF DESCRIPTION OF THE DRAWINGS

In the following, exemplary embodiments of the inventive concept are explained in greater detail, which are shown schematically in the drawings, in which:

FIG. 1 shows a grinding robot automatically grinding a wall surface in a room in a building,

FIG. 2 is a schematic sectional view through a grinding robot,

FIG. 3 is a schematic plan view of the grinding robot shown in FIG. 2,

FIG. 4 is a perspective view of the underside of the grinding robot,

FIG. 5 is a perspective view of the top of the grinding robot,

FIG. 6 is a schematic representation of several components of the grinding robot in a pulled-apart view, and

FIG. 7 is a schematic representation of a directional movement of the grinding robot housing over a surface.

### DETAILED DESCRIPTION

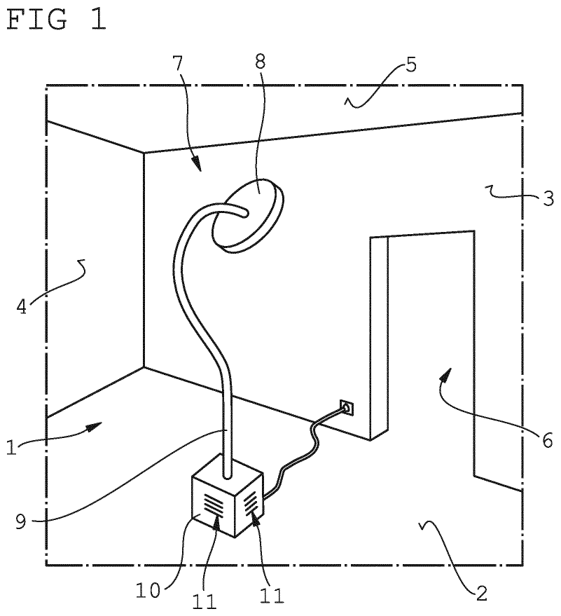

FIG. 1 schematically shows an interior 1 in a building. In the detail shown, the interior 1 is bounded by a floor surface 2, by a first and a second wall surface 3, 4 and by a ceiling surface 5. A door opening 6 is arranged in the first wall surface 3.

A grinding robot 7 with a grinding robot housing 8 is suctioned onto the first wall surface 3 by a suction device not shown in FIG. 1. The grinding robot housing 8 can be automatically moved over the first wall surface 3 using a movement device not shown in FIG. 1 and, in doing so, can grind the first wall surface 3 or a surface of the first wall using a grinding device not shown in FIG. 1. With the aid of a surface edge detection device, the grinding robot 7 can recognise edges of the first wall surface 3 during a grinding process and avoid collision with adjacent areas of the floor surface 2, the second wall surface 4 or the ceiling surface 5. In addition, the grinding robot 7 can also recognise the door opening 6 as a further edge of the first wall surface 3 and leave it out when moving it over the first wall surface 3.

The grinding robot housing 8 is connected to an extraction air filter device 10 placed on the floor surface 2 via an elastic plastics hose 9. An air flow drawn in via the suction device between the first wall surface 3 and the grinding robot housing 8 is fed through the plastics hose 9 to the suction air filter device 10. A filter device (not shown in detail) with a replaceable filter element is arranged in the extraction air filter device 10. Grinding dust generated during a grinding process is filtered out of the air flow by the filter device before the air flow is blown out into the surrounding environment or into the interior 1 through an air outlet 11 of the extraction air filter device 10.

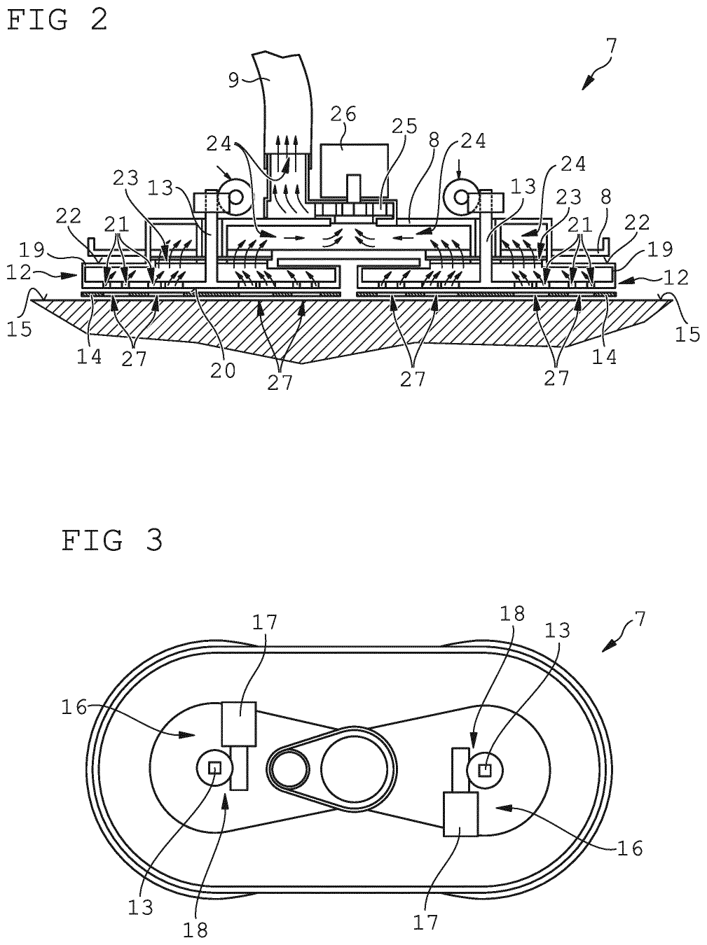

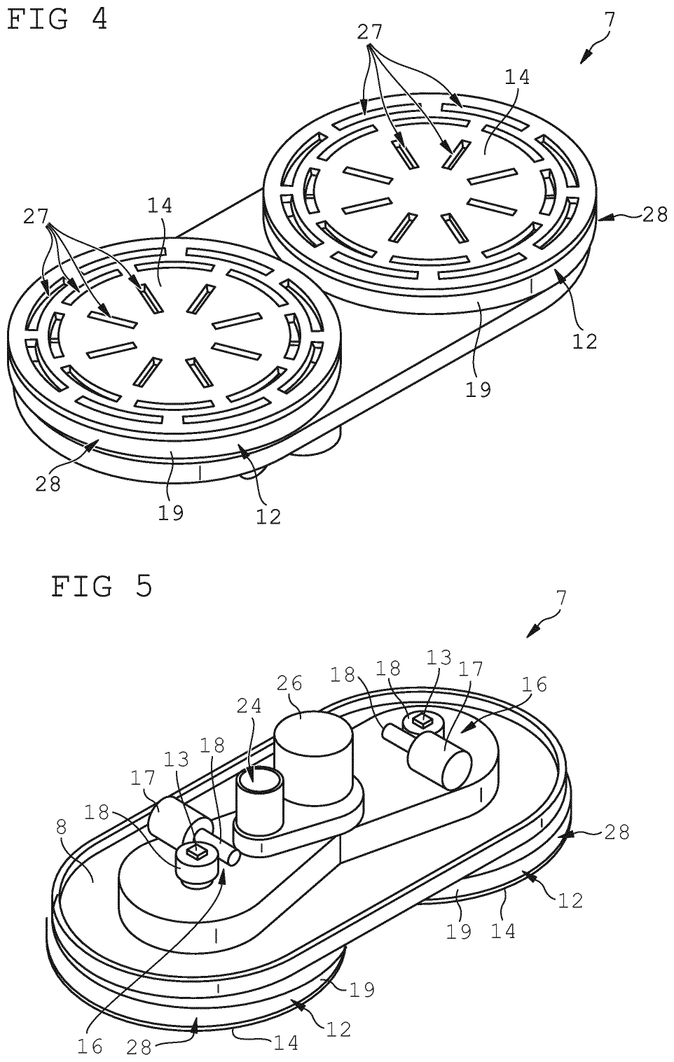

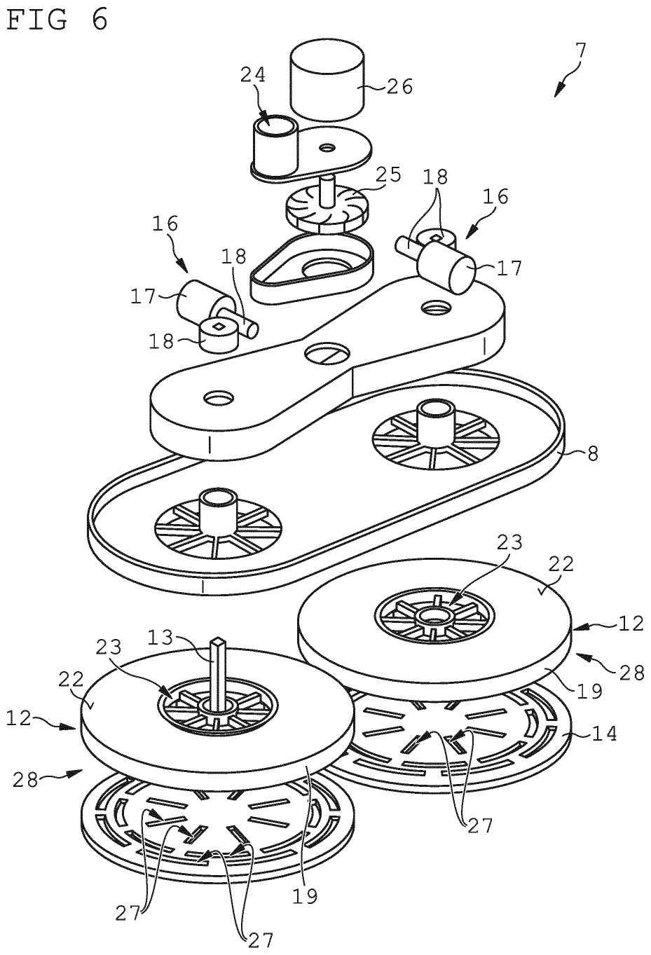

FIGS. 2 to 6 show a schematic sectional view and various views of the grinding robot 7. In a grinding robot housing 8, which is only partially shown, two grinding plates 12 are each rotatably arranged and supported on the grinding robot housing 8 via a rotatably mounted shaft 13. A grinding disc 14 is detachably attached to each grinding plate 12. A rotational movement of the grinding plate 12 causes the grinding disc 14 to rotate over a surface 15, thereby grinding the surface area covered by the grinding disc 14. A rotary drive device 16 is assigned to each grinding plate 12. Each rotary drive device 16 has an electric motor 17, which is operatively connected to the shaft 13 of the grinding plate 12 via a worm drive 18. The electric motor 17 can be used to set the grinding plate 12 relative to the grinding robot housing 8 either in a first slow rotary movement or in a second fast rotary movement for the rotational movement of the grinding plate 12 during a grinding process.

Each grinding plate 12 has a disc-shaped grinding plate housing 19. On a flat outer side 20 facing the grinding disc 14, the grinding plate housing 19 has several suction openings 21. Openings 23, which open into a suction channel 24, are also formed on an opposite outer side 22. An extraction fan 25 is arranged in the extraction duct 24, which can be set in rotation with the aid of a further electric motor 26 in order to draw in an air flow through the two grinding plate housings 19 and feed this air flow to the extraction air filter device 10 through the plastics hose 9 connected to the extraction duct 24. The grinding discs 14 also have openings 27, which are arranged in an at least partially overlapping manner with the suction openings 21 in the grinding plate housings 19, so that the air flow can be suctioned through the openings 27 in the grinding discs 14 and through the suction openings 21 into the grinding plate housing 19, in order to then flow through the openings 23 into the suction duct 24, from where it is conveyed by the suction fan 25 into the plastics hose 9 and into the suction air filter device 10.

By suctioning the air flow through the two grinding plate housings 19, a negative pressure is generated between the grinding plate housings 19 and the surface 15, which suctions the grinding plate 12 onto the surface 15 so that the grinding plate 12 and thus the grinding robot housing 8 are pressed against the surface 15. When the grinding plate 12 is set into a second rapid rotary movement with the associated rotary drive device 16, the grinding plate 12 is drawn to the surface 15 by the negative pressure and the grinding disc 14 rotates over the surface 15 with a contact pressure specified by the negative pressure, thereby grinding the surface 15.

If, on the other hand, the grinding plate 12 with the associated rotary drive device 16 is not set in a very slow first rotary movement or is only set in a very slow first rotary movement, the negative pressure generated on this grinding plate 12 is sufficient to suction the grinding plate 12 firmly onto the surface 15 and secure it there. The grinding plate 12 then acts as a suction lifter element 28, which is fixed and secured immovably on the surface 15. By actuating the rotary drive device 16, the grinding plate 12 is then not moved relative to the surface 15 with a first slow rotary movement, but the grinding robot housing 8 is rotated relative to the grinding plate 12, which has been suctioned onto the surface 15, thereby displacing the grinding robot housing 8 over the surface 15. By alternately using the two grinding plates 12 as a suction lifter element 28 and securing them to the surface 15, and by rotating the grinding robot housing 8 by an angle of, for example, 30 degrees around the grinding plate 12 which is suctioned onto and secured to the surface 15 before the other grinding plate 12 is used as a suction lifter element 28, a wave-shaped, directed movement of the grinding robot housing 8 over the surface 15 can be achieved.

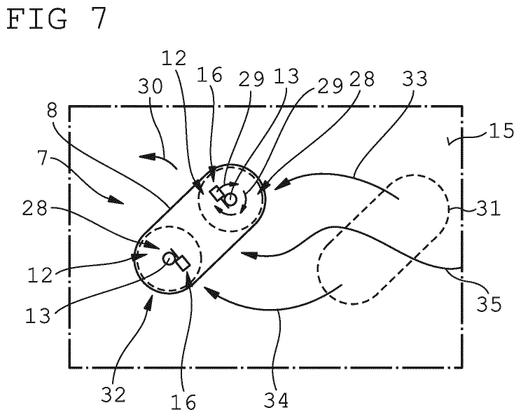

FIG. 7 illustrates various aspects of the directional movement of the grinding robot housing 8 over the surface 15. While in the operating state shown in FIG. 7, the grinding plate 12 located further down in the figure is used as a suction lifter element 28 and is suctioned on and secured to the surface 15, the other grinding plate 12 is set into a rapid second rotary movement indicated by a plurality of arrows 29 by the associated rotary drive device 16 and the surface 15 in a surface area covered by the grinding disc 14 is abraded by the rapidly rotating movement of the grinding plate 12 and the grinding disc 14 attached thereto. During the grinding process with the rapidly rotating grinding plate 12, the grinding robot housing 8 is slowly rotated about the suction lifter element 28 by the rotary drive device 16, which is associated with the fixed grinding plate 12 used as the suction lifter element 28, as indicated by an arrow 30. The grinding robot housing 8 is thereby pivoted about an axis of rotation of the grinding plate 12 located at the bottom and moved over the surface 15.

An earlier position 31 of the grinding robot housing 8 on the surface 15 is shown as a dashed line. From this earlier position 31, the grinding robot housing 8 was moved in two pivoting movements to the currently depicted position 32 by alternately using first the lower grinding plate 12 as a suction lifter element 28 and then the grinding plate 12 above it as a suction lifter element 28. A first pivoting movement is indicated by an arrow 33 and a subsequent second pivoting movement is indicated by an arrow 34. As a result of many such successive pivoting movements, the grinding robot housing 8 performs an undulating, directed movement over the surface 15, which is indicated by an undulating arrow 35. Through many successive directed movements, the grinding robot housing 8 can be moved over the entire surface 15 and the surface 15 can be ground with the respective rapidly rotating grinding plate 12.

1.-12. (Canceled)

13. A grinding robot (7) for grinding a surface (2, 3, 4, 5, 15), comprising:
a grinding device for grinding the surface (2, 3, 4, 5, 15) using a grinding means;
a movement device for moving the grinding device over the surface (2, 3, 4, 5, 15);
a grinding robot housing (8) on or in which the grinding device and the movement device are arranged; and
a suction device by which the grinding robot housing (8) is suctioned onto the surface (2, 3, 4, 5, 15) while a grinding process is being carried out with the grinding device.

14. The grinding robot (7) according to claim 13,
wherein the movement device has two or more suction lifter elements (28),
wherein the two or more suction lifter elements (28) are arranged spaced apart from one another and face the surface (2, 3, 4, 5, 15),
wherein the two or more suction lifter elements (28) are suctioned onto the surface (2, 3, 4, 5, 15) by a negative pressure that is generated by a negative pressure generation device, and
wherein each of the two or more suction lifter elements (28) is supported on the grinding robot housing (8) via a rotary drive device (16) whereby the grinding robot housing (8) can be set in a rotational movement relative to one of the two or more suction lifter elements (28) suctioned onto the surface (2, 3, 4, 5, 15) by the rotary drive device (16).

15. The grinding robot (7) according to claim 13,
wherein the grinding device has at least one grinding plate (12) with a grinding disc (14),
wherein the grinding disc (14) can be secured to the grinding plate (12), and
wherein the grinding disc (14) is set in a rotational movement by a rotary drive device (16).

16. The grinding robot (7) according to claim 15,
wherein a suction lifter element (28) or a plurality of suction lifter elements (28) is or are configured as a grinding plate (12),
wherein the grinding plate (12) has suction openings (21) spaced apart from a grinding plate edge for suctioning the grinding plate (12) onto the surface (2, 3, 4, 5, 15),
wherein the grinding disc (14) fastened to the grinding plate (12) has one or more openings (23) at a distance from a grinding disc edge, and
wherein the openings (23) are arranged in an at least partially overlapping manner with one or more of the suction openings (21) in the grinding plate (12).

17. The grinding robot (7) according to claim 16,
wherein the rotary drive device (16) is configured such that the grinding plate (12) can be set by the rotary drive device (16) either
into a first slow rotary movement for a rotational movement of the grinding robot housing (8) about the suction lifter element (28) suctioned onto the surface (2, 3, 4, 5, 15) or
into a second fast rotational movement for a rotational movement of the grinding plate (12) during the grinding process.

18. The grinding robot (7) according to claim 14,
wherein the negative pressure generation device has a suction fan (25),
wherein the suction fan (25) is connected to the two or more suction lifter elements (28) via a branching suction duct (24), whereby the negative pressure is generated at the two or more suction lifter elements (28) when the suction fan (25) is in operation.

19. The grinding robot (7) according to claim 18,
wherein the suction device has a valve device for controlling the negative pressure that is generated on the two or more suction lifter elements (28) with the negative pressure generation device.

20. The grinding robot (7) according to claim 14,
wherein the negative pressure generation device is connected via a suction hose (9) to a suction air filter device (10) arranged outside the grinding robot housing (8).

21. The grinding robot (7) according to claim 15,
wherein a grinding dust seal is arranged along a peripheral edge around each at least one grinding plate (12).

22. The grinding robot (7) according to claim 13,
wherein an energy storage device is arranged on or in the grinding robot housing (8), and
wherein the energy storage device is connected in an energy-transmitting manner to the grinding device, to the suction device, and/or to the movement device.

23. The grinding robot (7) according to claim 13, further comprising a contact pressure sensor device.

24. The grinding robot (7) according to claim 13, further comprising a surface edge detection device.
